(19) United States
(12) Patent Application Publication
(10) Pub. No.: US 2022/0174452 A1
(43) Pub. Date: Jun. 2, 2022

(54) METHODS AND APPARATUS FOR SELECTIVELY COMMUNICATING WITH MOBILE DEVICES

(71) Applicant: SITU8ED SA, Bernin (FR)

(72) Inventors: Rodric BARK, Bernin (FR); Nicolas DEFRANOUX, Grenoble (FR)

(21) Appl. No.: 17/600,316

(22) PCT Filed: Apr. 22, 2020
(86) PCT No.: PCT/EP2020/061216

§ 371 Date: Sep. 30, 2021

(30) Foreign Application Priority Data
Apr. 25, 2019 (GB) 1905787.6

(51) Int. Cl. H04W 4/021; H04W 12/64; H04W 12/75; H04W 4/029

(52) U.S. Cl. CPC H04W 4/021; H04W 4/029; H04W 12/75; H04W 12/64

(57) ABSTRACT

There is provided a computer-implemented method of selectively communicating with mobile devices. At each of a plurality of mobile devices, a travel mode between a plurality of locations is determined in dependence on one or both of: one or more sensors associated with each respective mobile device, and wireless location signals received at the mobile device. At each mobile device, at least some of the plurality of locations are selected as significant locations associated with a user of the respective mobile device. Each significant location is a location at which the user resides for extended durations of time. Each mobile device communicates to a server computer an identifier associated with each mobile device, a generalised identifier associated with each significant location and an indication of the travel mode to the significant location. At the server computer, a set of mobile devices is selected in dependence on one or more points of interest in a geographic region proximal to one or more of the significant locations associated with each mobile device. Data is communicated to the set of mobile devices.

### BACKGROUND

It is desired to selectively communicate, for example to selectively send data to, mobile devices. It may be desired to communicate with a subset of a group of mobile devices. The mobile devices are selected to communicate with based on their location or location history. By location history it is meant a history of one or more geographic locations visited by the mobile device.

In order to implement the selective communication, each mobile device of the group communicates location data indicative of a geographic location to a server computer. The location data is indicative of a current or previous geographic location visited by the mobile device. The location data is often in the form of geographic coordinates, such as longitude and latitude, of the mobile device. The server computer utilises the location data to select the subset of mobile devices with which to communicate, for example, to send data to. The selection may be made, for example, to select mobile devices which have visited a particular location or area within a period of time.

However, by the mobile devices communicating the location data to the server computer privacy concerns exist in that persons possessing the mobile device may be identified.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows a system according to an embodiment of the invention;

FIG. 2 shows a schematic illustration of a mobile device according to an embodiment of the invention;

FIG. 3 shows a schematic illustration of a server computer according to an embodiment of the invention;

FIG. 4 shows a method according to an embodiment of the invention;

FIGS. 5 & 6 illustrate data structures according to an embodiment of the invention;

FIG. 7a illustrates a method for determining significant locations according to an embodiment of the invention;

FIG. 7b illustrates example significant location data according to an embodiment of the invention;

FIGS. 8a and 8b each illustrate a method for transmitting information to a server computer according to an embodiment of the invention;

FIG. 9 illustrates a method for selectively transmitting data according to an embodiment of the invention;

FIG. 10 illustrates a method for tracking a mobile device with respect to a geofence according to an embodiment of the invention; and

FIG. 11 illustrates example digital media comprising geofence data according to an embodiment of the invention.

### DETAILED DESCRIPTION OF EMBODIMENTS OF THE INVENTION

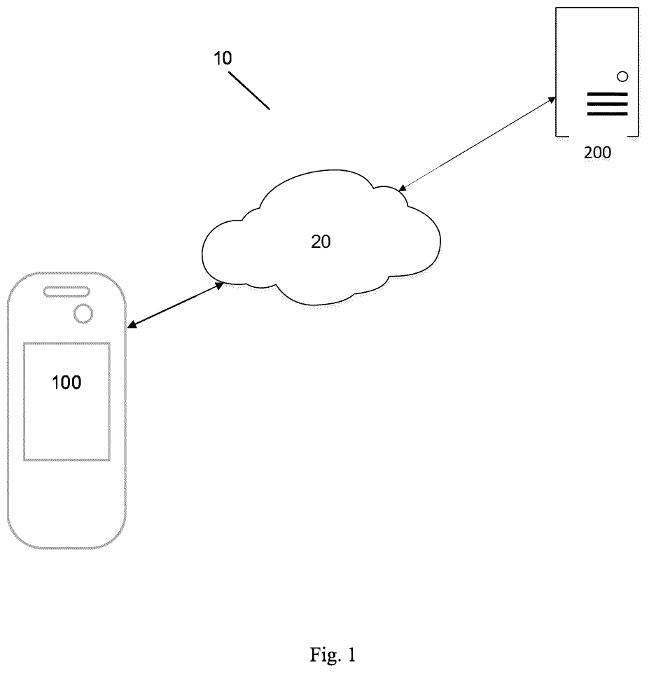

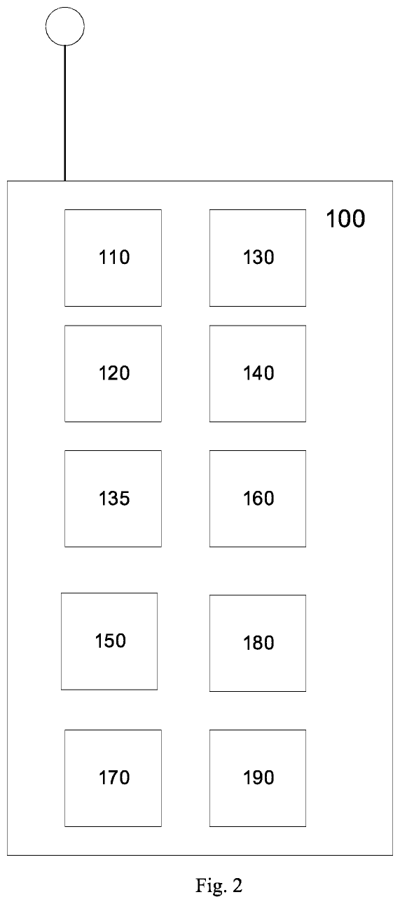

FIG. 1 illustrates a system 10 according to an embodiment of the invention. The system 10 is a system 10 for selectively communicating with mobile devices. FIG. 1 illustrates the system 10 comprising one mobile device 100 with it being appreciated that this is merely illustrative and that the system 100 may comprise a plurality of mobile devices 100. The system further comprises a server computer 200 which may be in the form of a cloud computing system 200. The server computer 200 and the mobile device 100 are able to communicate i.e. to exchange data via one or more networks illustrated in FIG. 2 as network 20. The network 20 may comprise one or more wired and wireless networks such as the Internet. At least some of the one or more wireless networks may operate according to a protocol such as 4G, 5G, LTE etc.

The mobile device 100 may be any portable computing apparatus including, but not limited to, a mobile telephone, tablet computer, wearable computing apparatus. Although not illustrated in FIG. 2 the mobile device 100, if not a worn computing apparatus itself, may be communicable with a worn computing apparatus such as a wristwatch having a processor able to execute computer-readable instructions.

FIG. 2 schematically illustrates a structure of the mobile device 100 according to an embodiment of the invention. The mobile device 100 comprises one or more electronic processors 110 and a memory 120. The memory 120 may store computer-readable instructions in the form of a computer program which is operatively executed by the one or more electronic processors 110. The memory 120 may also, in use, store data for processing by the processors 110. The memory 120 may be used to store digital map data. The digital map data is indicative of a geographic region as will be explained.

The mobile device 100 may further comprise a display unit 180 and one or more user interfaces 190. The display unit 180 may be a screen, for example an LCD or LED screen. Each user interface 190 is operative to receive input from a user of the mobile device 100. Each user interface 190 may for example be a keyboard, microphone or touch screen. In some embodiments, one or more of the user interfaces 190 may also function as the display unit 180.

The mobile device 100 further comprises a location determining module 130, an inertial measurement module (IMM) 135, a travel mode determination module (TMDM) 140, a significant location determination module (SLDM) 150 and an identifier determination module (IDM) 160. The mobile device 100 further comprises a communication module 170 for sending and/or receiving data via the network 20.

The location determining module 130 is operative to determine a geographic location of the mobile device 100. The geographic location may be determined using a predetermined coordinate system such as longitude and latitude. The location determining module 130 is arranged to determine the geographic location using received wireless signals. The signals may be signals broadcast by one or more geostationary satellites such as GPS, GLONASS, Galileo or other satellites. The signals may alternatively or additionally comprise wireless communication signals such as WiFi or signals of other wireless communication networks which may be used to establish, at least approximately, a geographic location of the mobile device 100 as will be appreciated.

The IMM 135 comprises one or more sensing devices for determining information about movement of the mobile device 100. The IMM 135 may determine one or more of position, velocity and attitude of the mobile device 100. The IMM 135 may comprise one or more of one or more accelerometers and gyroscopes. The IMM 135 may provide inertial measurement data at a sampling rate, such as 100 Hz, 500 Hz, or 1 Khz, although other sampling frequencies may be used. The inertial measurement data is stored in the memory 120. The inertial measurement data may also be used to determine the geographic location of the mobile device 100 particularly when the wireless signals used by the location determining module 130 are insufficient i.e. cannot be received to enable the location to be determined with precision.

As noted above, the memory 120 may store digital map data relating to one or more geographic regions. The mobile device 100 may obtain the digital map data from a map server such as Google Places or Open Street Maps through the communication module 170. The location determination module 130 is operative to determine a generalised location identifier representative of the geographic location of the mobile device 100. The generalised location identifier is determined such that a third party is unable to identify the user of the mobile device 100 from the generalised location identifier alone. The generalised location identifier may be determined in dependence on granulated location information extracted from the digital map data. The granulated location information may be, for example, a tile of the digital map data relating to the geographic location of the mobile device 100, or a truncated region identifier such as a postcode corresponding to an area relating to the geographic location of the mobile device 100.

The location determination module 130 is operative to determine generalised location information 630 associated with the location of the mobile device 100. The LDM 130 may determine the generalised location information 630 by extracting one or more location attributes embedded in the digital map data on, or proximate to, the location of the mobile device 100. For example, the digital map data may comprise embedded information such as classifications of places as different types, e.g. Shop, Office, Public Building etc. The classifications may be hierarchical, such that for a type classification such as a Shop, there may be several sub-types such as Supermarket, Fashion etc.

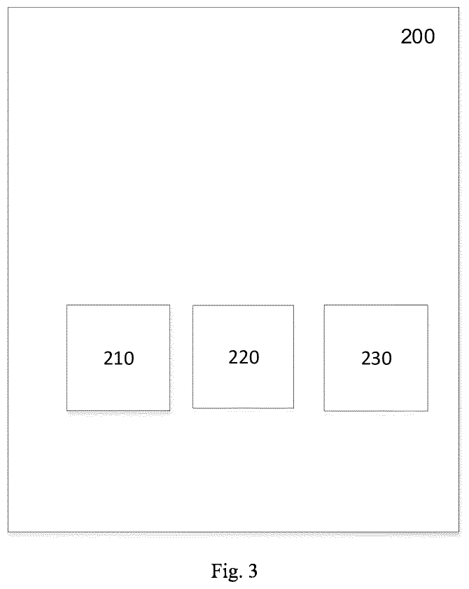

FIG. 3 schematically illustrates a structure of the server computer 200 according to an embodiment of the invention. The server computer 200 comprises one or more electronic processors 210 and a memory 220. The memory 220 may store computer-readable instructions in the form of a computer program which is operatively executed by the one or more electronic processors 210. The memory 220 may also, in use, store data for processing by the processors 210. The server computer 200 further comprises a communication module 230 for sending and/or receiving data via the network 20. In particular, the mobile device 100 and the server computer 200 may exchange data via the respective communication modules 170, 230 as will be explained.

The mobile device 100 according to an embodiment of the invention is operative to determine information indicative of locations visited by a user associated with the mobile device 100 i.e. locations to which the mobile device 100 is transported by the user. However, in order to preserve a privacy of the user of the mobile device 100, information indicative of those visited locations is not communicated from the mobile device 100. Instead, only a generalised identifier indicative of a visited location is communicated from the mobile device 100, as will be explained. The mobile device 100 is operative to select one or more visited locations as significant locations associated with the user of the mobile device 100. The mobile device 100 is further operative to determine a mode of travel (MoT) between those locations.

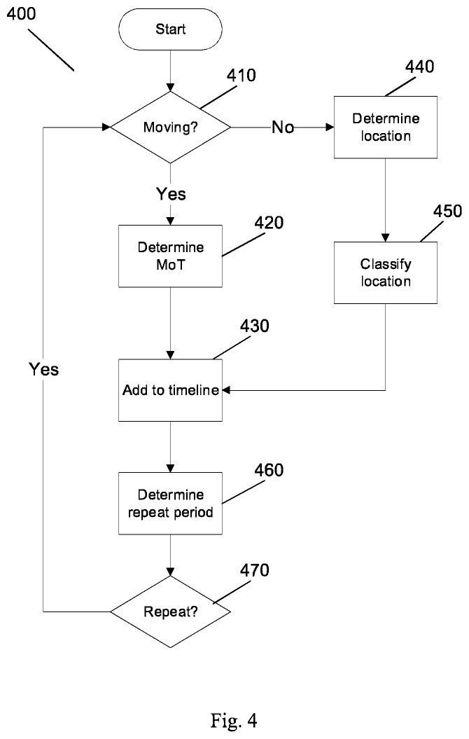

FIG. 4 illustrates a method 400 according to an embodiment of the invention. The method 400 is a method of determining travel information of the user of the mobile device 100. The method 400 aims to determine the travel information whilst minimising a power consumption of the mobile device 100 performing the method 400 as will be explained.

The method comprises an operation 410 of determining whether the mobile device 100 is moving, or ‘in-transit’. Operation 410 may be performed by the TMDM 140 using data from one or both of the location determining module 130 and the IMM 135. Operation 410 may comprise determining whether a location of the mobile device 100 has changed since a previous iteration of step 410. Determining whether the location of the mobile device 100 has changed may be dependent on a duration of time since the previous iteration of operation 410 i.e. the change of location may only be considered if the previous iteration was performed within a predetermined duration such as 5 minutes, or 1 minute in order to ensure that the current iteration of operation 410 is determining whether the location of the mobile device is changing at that time, rather than previously having changed. The change in location may be determined based on the wireless signals used by the location determining module 135. For example, the location determining module 130 may determine that the mobile device 100 is still wirelessly connected to a particular network, such as WiFi, as at the previous iteration of operation 410. The change in location may be determined based on the inertial measurement data where operation 410 comprises determining if the inertial measurement data is indicative of the mobile device 100 currently moving. For example, whether the mobile device 100 is experiencing changes in orientation or accelerations owing to movement.

If it is determined in operation 410 that the mobile device 100 is moving, method 400 progresses to operation 420. Operation 420 comprises determining a MoT of the mobile device 100. According to an embodiment of operation 420, the MoT of the mobile device 100 is determined by the TMDM 140. The MoT is indicative of a type of travel activity currently being undertaken by the mobile device 100. In some embodiments of the invention, the TMDM 140 utilises the inertial measurement data from the IMM 135 to determine the MoT. The TMDM 140 may determine the MoT based on previously recorded data relating to a plurality of predetermined travel modes, for example by utilising a decision tree. In some embodiments, each piece of previously recorded data may be labelled as a sample of one the plurality of travel modes. The decision tree may be developed by using the samples as input to an AI neural network or other learning algorithm. The plurality of travel modes may comprise at least some of walking, in-vehicle (driving or vehicle passenger), train, tram etc. Using the IMM 135 the TMDM 140 determines the MoT of the mobile device 100 in operation 420.

The TMDM 140 may also utilise one or more other parameters to determine the MoT. In some embodiments, the TMDM 140 may receive from the location determining module 130 a parameter indicative of the number of non-changing Wi-Fi signals or a parameter indicative of the presence of a GPS signal. In some embodiments, the TMDM 140 may retrieve the digital map data from the memory 120 and determine, from the digital map data, one or more proximity parameters. Each proximity parameter is indicative of the proximity of the mobile device 100 to a location type embedded in the digital map data. For example, the TMDM 140 may determine a parameter indicative of the proximity of the mobile device 100 to a type of transport infrastructure, e.g. a train line. The MoT may then be determined further in dependence on a combination of one or more of said parameters.

The MoT may be determined as one of the plurality of travel modes and thus operation 420 may comprise selecting one of the plurality of travel modes as a current travel mode of the mobile device 100.

Operation 430 comprises storing data indicative of the determined MoT. The data may be referred to as MoT data which is stored at the mobile device 100, such as in the memory 120. The MoT data is indicative of the MoT selected in operation 410.

In some embodiments of the invention, a timeline data structure is constructed. The timeline data structure provides information about travel segments, such as the MoT of the user of the mobile device 100 between a plurality of locations. The timeline data structure may further comprise temporal information about the travel segments and genericised information about locations visited by the user, as will be explained.

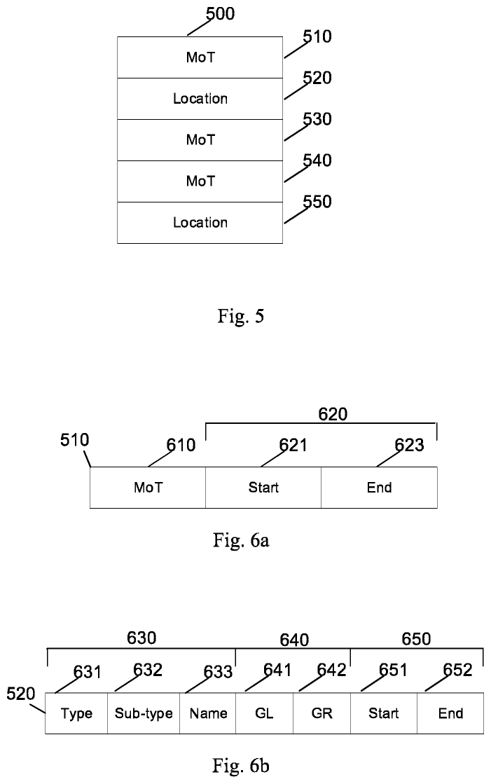

FIG. 5 illustrates an example timeline data structure 500 according to an embodiment of the invention.

As can be appreciated, the timeline data structure 500 comprises segments of travel data 510, 530, 540 and location data 520, 550. The timeline data structure 500 may relate to a predetermined period of time, such as one day, although other periods may be selected.

The travel segment information comprises an indication of MoTs determined in operation 420 and locations determined in operations 440, 450 as will be explained. As will be appreciated from FIG. 5, a plurality of MoTs 530, 540 may be determined between locations 520, 550 in the timeline where a plurality of travel modes are used between those locations 520, 550.

FIG. 6(a) illustrates example travel segment data from the timeline data structure 500 of FIG. 5. For example, the travel segment data may be travel data 510 from FIG. 5. The travel data 510 comprises an indication of the MoT 610 determined in operation 420. The travel data 510 further comprises temporal information 620 associated with the MoT 610. The temporal information 620 may comprise an indication 621 of a start time of the travel segment 510 and an indication of an end time 623, or a duration, of the travel segment 510.

FIG. 6(b) illustrates example location data from the timeline data structure 500 of FIG. 5. For example, the location data may be location data 520 as shown in FIG. 5. The location data 520 may comprise generalised location information 630 associated with a location visited by the mobile device 100, a generalised location identifier 640 according to one or more predetermined location or mapping systems associated with the location, and temporal information 650 associated with the visit to the location.

Each example travel segment data 510, 530, 540 may be added to the timeline data structure 500 during an iteration of operation 430.

If it is determined in operation 410 that the mobile device 100 is not moving, method 400 progresses to operation 440. Operation 440 comprises determining a location of the mobile device 100. The location of the mobile device is determined by the LDM 130, and may be represented in a co-ordinate system such as longitude and latitude. The LDM 130 may determine the location of the mobile device 100 using received wireless signals, for example one or both of signals broadcast by one or more geostationary satellites such as GPS, and triangulation of wireless communication signals such as WiFi. The LDM 130 may alternatively or additionally use other sources such as telecommunication cell data to determine the location of the mobile device 100. Operation 440 may comprise the LDM 130 polling, i.e. repeatedly determining, the location a plurality of times, to improve the accuracy of the determined location. After a location of the mobile device 100 is determined in operation 440, method 400 progresses to operation 450.

Operation 450 comprises classifying the location of the mobile device 100 as determined in operation 440. Operation 450 is performed by the LDM 130. The location of the device 100 may be classified as one or both of generalised location information 630 associated with the location, and a generalised location identifier 640 according to one or more predetermined location or mapping systems.

The LDM 130 may determine the generalised location identifier 640 in dependence on the location of the mobile device 100 and the digital map data stored in the memory 120.

In some embodiments, the digital map data may comprise a plurality of tiles each corresponding to a predefined area of the map, and for each of the plurality of tiles an associated tile identifier. Operation 450 may comprise associating the location determined in operation 440 with one of the plurality of tiles. For example, the location may be a set of co-ordinates (A, B). In operation 450 the LDM 130 may retrieve the digital map data and associate the location (A, B) with the tile of the digital map data containing the co-ordinates (A, B). The generalised location identifier 640 may in some embodiments incorporate the tile identifier 641.

In some embodiments, the digital map data may comprise a plurality of geographic regions each associated with a unique region identifier 642, for example a postcode, PIN or ZIP Code. The region identifier 642 may be any identifier, for example an alphanumeric string or binary code, and the relationships between the plurality of regions and the region identifiers may be embedded in the map data or stored separately in memory 120. The region identifier 642 may be hierarchical, in that the full region identifier may be associated uniquely with a first region, but a truncated version of the region identifier may be associated with a larger region comprising the first and other regions. For example, Al2AAA may be associated with a first street, Al2AA with a collection of streets comprising the first street, and Al2A with a neighbourhood comprising the collection of streets. It will be appreciated that this is merely an illustrative example, and the region identifier may be implemented in alternate ways. Operation 450 may comprise determining the region identifier associated with a region containing the location of the mobile device 100. The generalised location identifier may then incorporate the region identifier 642. Operation 450 may comprise truncating the region identifier 642 to reduce the resolution of the location identified.

The generalised location identifier 640 may then be defined in dependence on one or both of the tile identifier 641 and the region identifier 642.

The LDM 130 may determine the generalised location information 630 associated with the location of the mobile device 100 in dependence on the digital map data stored in memory 120. The generalised location information 630 may comprise information embedded in the digital map data associated with locations on the digital map. As has been explained the digital map data may comprise embedded information such as classifications of places as different types, e.g. Shop, Office, Public Building. The classifications may be hierarchical, and for a type classification such as a Shop, there may be several sub-types such as Supermarket, Fashion etc. The LDM 130 may determine the generalised location information 630 in dependence on one or more of the type of location 631 (for example Shop, Office), one or more specific sub-types 632 (for example Supermarket) and optionally a label 633 of the franchise (e.g. Tesco, Asda) associated with the location of the mobile device 100. The level of detail added to the generalised location information 630 may depend on the identifiability of the specific location from the labels 631, 632, 633. For example, if there are a large number of locations within the digital map data with the same franchise label (e.g. Tesco) the identifiability of the location of the mobile device from the franchise label 633 would be low, and so the LDM 130 may include franchise label 633 in the generalised location information 630. Conversely, if the franchise label 633 is only associated with a small number of locations in the digital map data then the identifiability of the location of the mobile device 100 from the franchise label 633 would be high. Therefore, to improve the privacy of the user of the mobile device 100 from any entity accessing the generalised location information 630, the LDM 130 may not include the franchise label 633 in the generalised location information 630 when the number of locations in the digital map data associated with the franchise label 633 is below a predetermined quantity, for example 30 locations.

The LDM 130 may classify the location as a combination of the generalised location identifier 640 and the generalised location information 630.

Once the LDM 130 has classified the location of the mobile device in operation 450, method 400 progresses to operation 430. Operation 430 comprises storing data indicative of the classified location such as location data 520. The location data 520 may be stored on the mobile device 100, such as in the memory 120. The location data 520 is indicative of the granulated or classified location information inferred from the location of the mobile device in operation 450. The location data stored in operation 430 does not comprise the accurate location co-ordinates determined in operation 440 but rather the generalised location information 630 and generalised location identifier 640 determined in operation 450. In this way, the location data 520 stored in operation 430 would not be specific enough to identify an individual, thereby improving privacy.

As discussed previously, in some embodiments of the invention, a timeline data structure 500 is constructed as illustrated in FIG. 5. Operation 430 may then comprise adding to the timeline data structure the location data 520, 550 about the location visited by the user.

FIG. 6(b) illustrates example location data 520, 550 comprising the generalised location information 630 and the generalised location identifier 640. Furthermore, in some embodiments the location data 520, 550 may comprise temporal information 650 associated with the duration of time spent at the location. For example the location data 520, 550 may comprise a start time 651 and an end time 652 which may be determined in dependence on the temporal information of the previous timeline segment and the time at which the location was determined in operation 440.

Each example segment of location data 520, 550 may be added to the timeline data structure 500 during an iteration of operation 430.

After the data indicative of the MoT (travel data 510, 530, 540) or location (location data 520, 550) is stored in operation 430, method 400 proceeds to operation 460. Operation 460 comprises determining a repeat period for the method 400. The repeat period may be defined as a minimum amount of time to have elapsed before method 400 returns to the operation 410. The operation 460 may be performed by processor 110. The repeat period is determined contextually in dependence on the location or

MoT data stored in operation 430 and defines how often and to what extend operations 410 to 450 should be repeated.

If the data stored in operation 430 is MoT data, then the repeat period may be determined in operation 460 in dependence on the MoT 610. A repeat period for each MoT may be predetermined and stored, for example in memory 120. Operation 430 may then comprise retrieving the corresponding repeat period for the MoT 610. The repeat period may be associated with the likelihood of arrival at a location or a different MoT imminently. For example, if the MoT 610 is indicative of travel on foot, the repeat period may be determined to be 1 minute because the likelihood may be high that the user may arrive at a location or change to a different MoT at any moment. If the MoT 610 is indicative of travel by train, the repeat period may be determined to be 5 minutes, i.e. longer than the repeat period for travel on foot, because if the user is on a train it is less likely the journey will imminently end or the MoT imminently change. It will be appreciated that any repeat period may be associated with any MoT.

If it was determined in operation 410 that the mobile device 110 was not moving, and so the data stored in operation 430 is location data 520, the repeat period may be determined in dependence on the location.

In some embodiments, if the mobile device 100 was determined to be not moving, it may be desired to only end the repeat period when basic movement is detected, in order to conserve battery. For example, basic movement detection may be performed analogously to operation 410. In this way, battery consumption is kept to a minimum as polling for basic movement is not battery intensive and superfluous recording of location data and movement data is avoided while the device is static. In these embodiments, operation 460 may comprise defining a movement polling period. Operation 460 may comprise performing a movement detection at periodic time intervals as defined by the movement polling period, for example through IMM 135.

After the repeat period and any further criteria such as the movement polling have been defined in operation 460, method 400 then proceeds to operation 470. Operation 470 comprises determining if all criteria determined in 460 have been satisfied. For example, operation 470 may comprise determining if the repeat period has elapsed. In embodiments wherein basic movement detection is performed periodically in operation 460, operation 470 may comprise determining if basic movement has been detected.

If any criteria determined in operation 460 have not been met, method 400 remains at operation 470. Once all determined criteria have been met, operation 470 determines that the repeat period has elapsed and method 400 proceeds to return to operation 410. Method 400 may be performed constantly or periodically by mobile device 100, thereby producing a timeline data structure 500 comprising travel data 510 and location data 520 for the mobile device 100, as has been explained.

Concurrently or periodically at intervals during the method 400, the mobile device may perform an embodiment of a method 700.

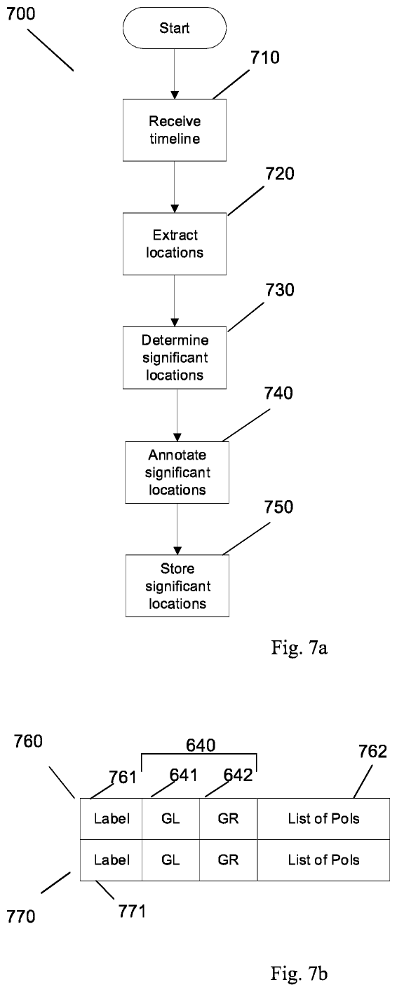

An embodiment of the method 700 is illustrated in FIG. 7a. The method 700 defines a method of determining one or more significant locations 760, 770 associated with the mobile device 100. Each significant location 760, 770 may be defined as a location at which the user of the mobile device 100 spends a significant period of time, for example at home and at work. Method 700 is performed on the mobile device 100, for example by significant location determination module (SLDM) 150. In some embodiments the SLDM 150 may perform method 700 after a predetermined period of time, or when the timeline data structure 500 reaches a minimum size, i.e. when the timeline data structure 500 covers a minimum period of time or contains a predetermined number of segment entries 510, 520.

The method 700 comprises an operation 710 of receiving timeline data, for example timeline 500. The timeline 500 may be retrieved from storage, for example from memory 120. The timeline 500 may comprise segments of travel data 510, 530, 540 and segments of location data 520, 550 as has been explained. The timeline may be constructed and stored as has been described with reference to the method 400.

The method 700 comprises an operation 720 of extracting locations from the timeline data. Operation 720 may comprise identifying each unique generalised location identifier 640 stored in the location data 520, 550 in the timeline. Each generalised location identifier 640 is representative of a location visited by the user of the mobile device 100. By extracting each unique generalised location identifier 640, the method 700 obtains a list of each unique location visited by the user of the mobile device 100.

The method 700 comprises an operation 730 of determining one or more significant locations of the mobile device 100. Operation 730 may be performed concurrently to operation 720, and for each generalised location identifier 640 extracted in operation 720 determining if the location is significant. In other embodiments operation 730 may be performed subsequently to operation 720, and the significant locations may be determined after all the generalised location identifiers have been extracted from the timeline.

Operation 730 may comprise determining whether a generalised location identifier 640 meets one or more significance criteria. If the location identifier meets the one or more criteria, the SLDM 150 may determine that the location is a significant location 760, 770.

The significance criteria may be associated with the timing and frequency of visits to the location represented by the generalised location identifier. For example the significance criteria may comprise one or both of an amount of time a user of the mobile device spends at the location, or a frequency at which the user of the mobile device visits the location. The significance criteria may also be derived from the times of day at which the user of the mobile device visits the location. Each of these criteria may be derived from the temporal information 650 associated with each occurrence of the generalised location identifier recorded on the timeline 500.

In some embodiments, operation 730 may comprising determining two or more significant locations 760, 770 each with different significance criteria. The two or more significant locations may each be given a respective label 761, 771. For example, operation 720 may comprise determining a significant location 760 with label 761 ‘Home’ and a significant location 770 with label 771 ‘Work’.

The significance criteria for the ‘Home’ location 760 and the ‘Work’ location 770 may differ, for example in the classification of each location embedded in the digital map data (Office, Residential etc), quantity of time spent static at each location and the time of day at which the mobile device 100 is static or present at each location, hence the different significance criteria. Operation 720 may comprise determining which of the generalised location identifiers 640 extracted in step 700 best match the significance criteria for each of the significant locations, and determining each of the significant locations in dependence thereon.

Each significant location determined in step 730 comprises a generalised location identifier 640 extracted from the timeline 500. The significant location is thus not determined to the level of location co-ordinates, but rather to the granulated level of the generalised identifier 640 as has been explained. Therefore privacy of the user of the mobile device 100 is better protected from any party accessing data comprising the significant locations.

Optionally, method 700 may then comprise a step 740 of annotating the significant locations. Step 740 may comprise determining a list 762 of proximate Points of Interests (Pols) to each of the significant locations from the digital map data stored in memory 120. The proximate PoIs may be features embedded in the digital map data. The features embedded in the digital map data may be hierarchical classifications of places, as has been explained, comprising different types (Shop, Office e.g.), one or more sub-types (Supermarket e.g.) and franchise or business labels (e.g. Tesco).

Step 740 may comprise determining a list of PoIs within or proximate to the area of the digital map data associated with the generalised location identifier of the significant location. For example, if the generalised location identifier 640 comprises a tile identifier 641, step 740 may comprise determining a list of PoIs within the map tile associated with the tile identifier, or within any predefined distance from the tile, for example in adjacent tiles.

If the generalised location identifier 640 comprises a region identifier 642, step 740 may comprise determining a list of PoIs sharing the region identifier 642 or a truncated part of the region identifier 642. For example, if the region identifier 642 is a postcode A20 4, step 740 may comprise determining a list of PoIs within the area with the postcode A20 4, or sharing the truncated postcode A20. Alternatively the PoIs may be determined as those within a predetermined distance from the area associated with the region identifier 642, for example within 0.5 km of postcode A20.

Step 740 may comprise including in the list of PoIs a parameter for each PoI indicating the proximity of the PoI to the significant location 760, 770.

Method 700 comprises a step 750 of storing the significant locations 760, 770. Step 750 may comprise storing the significant locations on the mobile device 100 for example in memory 120, or transmitting the significant locations through communication module 150 to the server computer 200.

FIG. 7(b) illustrates example significant locations 760, 770 stored in step 750. Although FIG. 7(b) illustrates two significant locations 760, 770, it will be appreciated that any number of significant locations may have been determined in step 730 and stored in step 750. Each significant location stored in step 750 comprises a generalised location identifier 640. The precise location of the significant location is thus not stored, but rather granulated information as a generalised identifier 640 as has been explained. Therefore, privacy of the user of the mobile device 100 is better protected from any party accessing data comprising the significant locations.

Each significant location 760 may be stored in step 750 with the annotated list of Pols 762 determined in step 740.

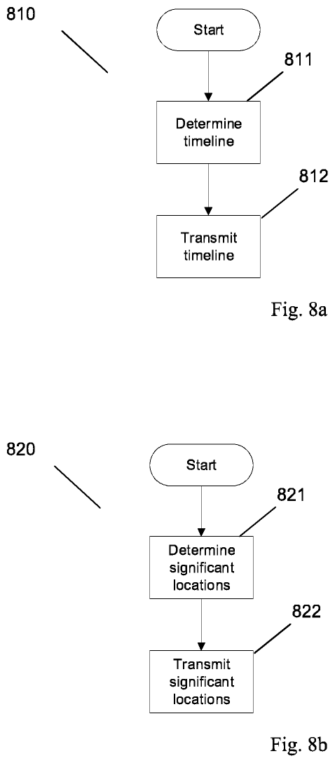

In some embodiments of the invention, one or both of the timeline 500 and the significant locations 760, 770 are periodically transmitted to the server computer 200 through for example communication module 170. Transmission to the server computer 200 is illustrated in FIG. 8.

FIG. 8a illustrates a method 810 for transmitting the timeline 500 to the server computer 200. Method 810 may be performed at predetermined intervals, or when one or more criteria are satisfied, for example when the timeline 500 reaches a certain size. Method 810 comprises a step 811 of determining the timeline. Step 811 may for example comprise performing method 400, or retrieving a timeline 500 stored in memory 120. Method 820 comprises a step 812 of transmitting the timeline to the server computer 200, for example via communication module 170. Step 812 may comprise transmitting the timeline 500 alongside an identifier (ID) for the mobile device 100 to allow the server computer 200 to uniquely associate the timeline 500 with the mobile device 100.

FIG. 8b illustrates a method 820 for transmitting the significant locations 760, 770 to the server computer 200. Method 820 may be performed at predetermined intervals, or when one or more criteria are satisfied, for example each time the significant locations are stored in method 700. Method 820 comprises a step 821 of determining the significant locations 760, 770. Step 821 may for example comprise performing method 700, or retrieving the significant locations 760, 770 stored in memory 120.

Method 820 comprises a step 822 of transmitting the timeline to the server computer 200, for example via communication module 170. Step 822 may comprise transmitting the timeline 500 alongside the identifier (ID) for the mobile device 100.

The server computer 200 may receive timelines 500 and significant locations 760, 770 from a plurality of mobile devices 100, each performing methods 810 and 820. The server computer 200 may then store each timeline 500 and significant location 760 in memory 220 together with the ID of the origin mobile device 100, for example compiled in a database. The database may be periodically updated each time new data is received from a mobile device 100 performing method 810 or 820.

The server computer 200 may then utilise the compiled data to selectively transmit data to a plurality of the mobile devices 100.

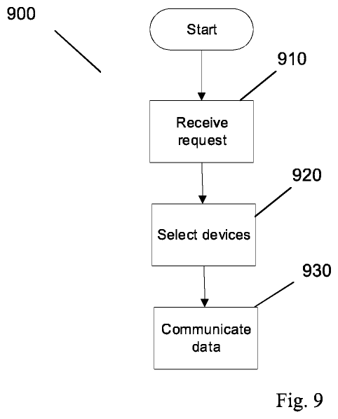

FIG. 9 illustrates an embodiment of a method 900 performed at the server computer 200 for selectively transmitting data, such as digital media, to a selected one or more mobile devices 100. For example, it may be desired to only transmit data to one or more mobile devices 100 who frequently travel to or within a predetermined distance of one or more PoIs with a particular label, for example supermarkets or restaurants. In some embodiments, it may be desired to only transmit data to one or more mobile devices 100 who frequently travel by a particular MoT. In some embodiments, aspects of the method 900 may be performed at each mobile device 100, as will be explained.

The method 900 comprises a step 910 of receiving a request to transmit data. The request is received by the server computer 200. The request received in step 910 may comprise a piece of data to be transmitted, for example a video, image or other piece of digital media and one or more criteria for recipient mobile devices 100.

The criteria may comprise one or more locations on the digital map data or one or more types 631, sub-types 632 or labels 633 of Points of Interest (Pols) embedded in the digital map data. For example, the criteria may comprise PoIs with type ‘Shop’, sub-type ‘Supermarket’. The criteria may comprise an indication that the one or more locations, types 631, sub-types 632 or labels 633 should be proximate to a significant location 760, 770.

The criteria may comprise one or more MoTs 610, for example the criteria may comprise the MoT ‘travel by train’. The criteria may comprise temporal information associated with the location type 631, 632, 633 or MoT 610. For example, the criteria may comprise ‘travel by train’ and ‘Monday’ to specify users whose timeline 500 comprises travel data 510 indicating the MoT 610 ‘travel by train’ and temporal information 621, 622 indicating the travel occurred on a Monday.

Method 900 comprises a step 920 of selecting a set of mobile devices in dependence on the criteria received in step 910. In some embodiments, step 920 may be performed on the server computer 200. Step 920 may comprise identifying in the database the IDs of mobile devices with significant locations 760, 770 proximate to PoIs 762 that meet the criteria received in step 910. For example, if the criteria is Pols with sub-type ‘Supermarket’, step 920 may comprise identifying mobile devices with significant locations 760, 770 in the database with at least one ‘Supermarket’ in the list of proximate Pols 762.

Step 920 may comprise identifying in the database the IDs of mobile devices with timeline segments 510, 520 meeting the criteria received in step 910. For example, if the criteria comprises ‘travel by train’ and ‘Monday’, step 920 may comprise identifying mobile devices 100 wherein the associated timeline 500 comprises travel data 510 indicating the MoT 610 ‘travel by train’ and temporal information 621, 622 indicating the travel occurred on a Monday.

Step 920 may then comprise compiling a list of the IDs of the mobile devices 100 meeting the criteria received in step 910.

In other embodiments, step 920 may be performed in part on the mobile devices 100. Step 920 may comprise sending the criteria received in step 910 to each of the mobile devices 100 via the communication modules 230 and 170. Step 920 may then comprise determining, at each mobile device 100, whether the mobile device 100 meets the criteria received in step 910, in dependence on one or both of the timeline data structure 500 and significant locations 760, 770 stored in memory 120. Advantageously, in these embodiments the server computer 200 does not require access to the timelines or significant locations of each mobile device, as the determination is made on each mobile device 100. Step 920 may then comprise transmitting, from each mobile device 100 to the server computer 200, an indication of whether the criteria are met. The server computer 200 may then select a list of mobile devices 100 indicated as meeting the criteria.

Method 900 comprises a step 930 of communicating the data received in step 910 to the set of mobile devices selected in step 920. For example, the server computer 200 may communicate the data via communication module 230 to the respective communication module 170 of each of the selected mobile devices.

When data is communicated from a server computer 200 to the selected mobile devices 100 as in method 900, it may be desired for the server computer 200 to determine if the behaviour of the user of each of the selected mobile devices 100 has been influenced by accessing or interacting with the communicated data. For example, when the data sent to each mobile device 100 comprises an associated PoI or other location on the digital map data, it may be desired to inform the server computer 200 if after accessing the communicated data, the user of each selected mobile device 100 visits the associated PoI or other location. To protect the privacy of the user of each mobile device 100, information sent to the server computer 200 should not allow the user of each mobile device 100 to be directly identified. Thus it is important that the server computer 200 should not be able to track the location of the user of each mobile device 100 with respect to any exact time. Aspects of the present invention address providing the server computer 200 with feedback regarding whether the user of each mobile device 100 visited a predetermined location within a time window, granulated such that the privacy of the user is maintained.

According to some embodiments of the invention there is provided a method 1000 of tracking a mobile device with respect to a geofence, i.e. a virtual geographic boundary or virtual perimeter. The geofence is not limited to any specific shape or size, but may be any arbitrary shape.

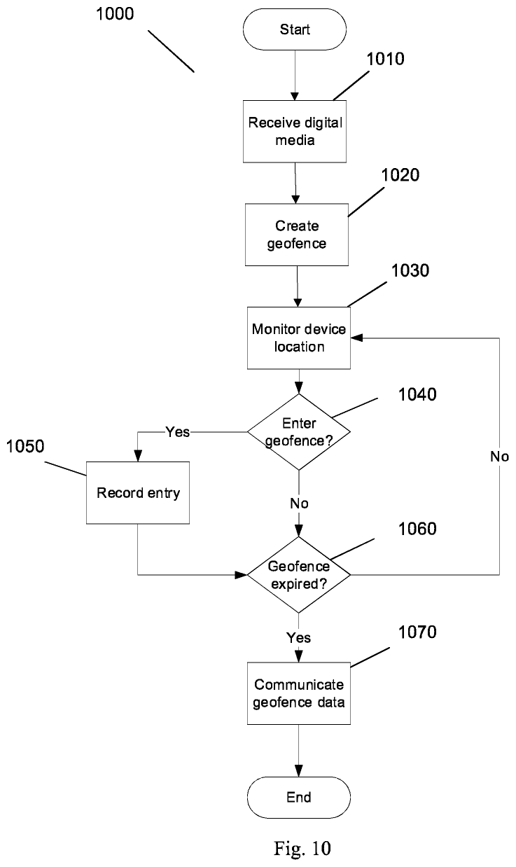

An embodiment of the method 1000 is illustrated in FIG. 10. Method 1000 is performed on the mobile device 100, for example by processor 110. In particular, method 1000 may be performed on at least some of the mobile devices 100 selected in step 920.

The method 1000 comprises a step 1010 of receiving digital media 1100 comprising geofence data 1120.

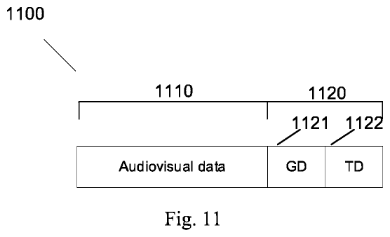

An illustration of the digital media 1100 is illustrated in FIG. 11. The digital media 1100 may comprise audiovisual data 1110, for example one or more video, image or audio files. The digital media 1100 may, in some embodiments, comprise the piece of data communicated to mobile devices in step 930 of the method 900. In this way, method 1000 and method 900 may be implemented in conjunction, and elements of method 1000 may form part of step 930. The geofence data 1120 comprises geographic data 1121 indicative of a geographic area and a temporal duration 1122.

In some embodiments, the geographic data 1121 is associated with one or more areas on the digital map data. For example, the one or more areas on the digital map data may be defined as the area associated with one or more tiles of the digital map data, or the area associated with one or more region identifiers, as has been explained. The one or more areas on the digital map data may comprise an area within a predetermined radius of one or more Points of Interest (Pols) on the map, as have been explained.

The temporal duration 1122 may be defined as a predetermined period of time, for example 1 hour, 2 hours, 1 day etc. The temporal duration 1122 may be defined as a time interval comprising a start and an end time. The start time may in some embodiments be defined as the time at which the digital media 1110 is received in step 1010 or accessed as in step 1020, and the end time may be defined to be a predetermined period after the start time. The end time or end of the predetermined time period may be associated with an expiry of the geofence, as will be explained.

The method 1000 comprises a step 1020 of creating the geofence in dependence on the mobile device 100 accessing the digital media 1110. For example, it may be determined that the mobile device 100 accesses the digital media 1110 when the digital media 1110 is received in step 1010. In some embodiments, the digital media 1110 may be determined to be accessed when it is output, such as displayed by the mobile device 100, for example on display 180. In some embodiments, the digital media 1110 may be determined to be accessed when a user of the mobile device 100 interacts with the digital media 1110 for example through user interface 190. When it is determined that the digital media 1110 has been accessed, the geofence is created in step 1020. The geofence may be created by loading the geofence data into memory 120.

The geofence may comprise a boundary or perimeter of the geographic area corresponding to the geographic data 1121 and an expiry corresponding to the temporal duration 1122 received in step 1010. The geofence may be determined to be triggered if the location of the mobile device 1000 falls within the boundary of the geofence before the expiry of the geofence. Step 1020 may comprise defining the boundary of the geofence by the boundaries of the one or more areas on the digital map associated with the geographic data 1121.

In some embodiments, step 1020 may comprise defining the expiry of the geofence as a time at which the geofence will expire. The expiry of the geofence may be determined in dependence on the temporal duration 1122. In some embodiments, the expiry of the geofence is defined as the end time associated with the temporal duration 1122. The expiry of the geofence defines the end time after which the geofence may not be triggered by the mobile device 100.

The method 1000 comprises a step 1030 of monitoring the location of the mobile device. Step 1030 may be performed by the LDM 130 analogously to operation 440. Step 1030 may be performed constantly or periodically, i.e. at predetermined intervals.

Concurrently to performing step 1030, the mobile device 100 may periodically perform step 1040. Step 1040 comprises determining whether the mobile device 100 has triggered the geofence. The geofence is determined to have been triggered if the location of the mobile device 100 determined in step 1030 falls within the boundary of the geofence, i.e. when the mobile device 100 enters the one or more areas associated with the geographic data 1121. The geofence remains determined to have been triggered regardless of whether the user of the mobile device 100 subsequently leaves the one or more areas associated with the geographic data 1121. For the geofence to be determined as triggered, the location of the mobile device 100 only needs to fall within the boundary of the geofence at least once before the expiry of the geofence.

If it has been determined in step 1040 that the mobile device 100 has triggered the geofence, the method 1000 proceeds to step 1050. Step 1050 comprises recording at the mobile device 100 that the geofence has been triggered by the mobile device 100. For example, step 1050 may comprise storing an indication that the mobile device 100 has triggered the geofence, for example in memory 120. In some embodiments, step 1050 may only be performed the first time the mobile device 100 triggers the geofence. The mobile device 100 may enter and leave the geographic area multiple times before the expiry of the geofence, and step 1050 may only be performed once to indicate that the geofence has been triggered at least once.

Subsequently to step 1020, for example concurrently or subsequently to step 1040, the mobile device 100 may periodically perform step 1060. Step 1060 comprises determining whether the geofence has expired. Step 1060 may comprise determining whether or not the expiry of the geofence has occurred, i.e. whether the temporal duration 1122 has elapsed.

While the geofence is determined not to have expired in step 1060, the method 1000 proceeds to periodically perform steps 1030, 1040 and 1060 as has been described. Once the geofence is determined to have expired in step 1060, the method 1000 proceeds to step 1070.

In step 1070, the mobile device 100 communicates geofence data to an external device, for example to server 200. The mobile device 100 may communicate the geofence data via communication module 170. The geofence data comprises an indication of whether the mobile device 100 triggered the geofence before the expiry, for example an indication of whether the geofence has been recorded as triggered during step 1050.

The geofence data comprises an indication that the geofence has or has not been triggered at some point between creation and expiry, however does not comprise detail of the exact time point at which the mobile device 100 entered the geofence. Advantageously, this protects the privacy of the user of the mobile device 100 as the geofence data does not comprise information that would allow a third party to deduce the location of the user at a specific time point. Furthermore, the geofence data is sent after the expiry of the geofence and thus the time at which the geofence data is communicated in step 1070 is unrelated to the time at which the geofence is triggered by the user of the mobile device 100. Therefore, the geofence data is communicated in step 1070 such that it does not comprise potential identifying information regarding the user of the mobile device 100.

Aspects of the present invention including methods 400, 700, 900 and 1000 may be performed in isolation or concurrently on a server computer 200 and/or one or more mobile devices 100. The present invention provides a framework wherein the server computer 200 can communicate data tailored to a subset of the mobile devices 100 based on their location based behaviour, while maintaining privacy of the users. Furthermore, aspects of the present invention enable the server computer to receive information regarding whether subsequently to interacting with said data, the user of the mobile device visits a predetermined location. Throughout each of the methods the privacy of the user is maintained, as the information provided to the server computer 200 is not sufficient for a third party to deduce the exact location of the user at any particular time.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computer-implemented method of selectively communicating with mobile devices, the method comprising:
determining, at each of a plurality of mobile devices, a travel mode between a plurality of locations in dependence on one or both of one or more sensors associated with each respective mobile device and wireless location signals received at the mobile device;
selecting, at each mobile device, at least some of the plurality of locations as significant locations associated with a user of the respective mobile device, wherein each significant location is a location at which the user resides for extended durations of time;
communicating, from each mobile device to a server computer, an identifier associated with each mobile device, a generalized identifier associated with each significant location and an indication of the travel mode to the significant location;
selecting, at the server computer, a set of mobile devices in dependence on one or more points of interest in a geographic region proximal to one or more of the significant locations associated with each mobile device; and
communicating data to the set of mobile devices.

2. The method of claim 1, further comprising, at each of the mobile devices:
determining periodically whether the mobile device is static or in-transit;
if the mobile device is static, determining a generalized identifier associated with the location of the mobile device and determining location data in dependence thereon;
if the mobile device is in-transit, determining the travel mode of the mobile device and determining transport data in dependence thereon; and
constructing a timeline data structure for the mobile device in dependence on the location data and transport data.

3. The method of claim 2, further comprising, at each mobile device periodically communicating the timeline data structure to the server computer.

4. The method of claim 2, wherein, at each mobile device the significant locations are selected in dependence on the timeline data structure.

5. The method of claim 1, wherein the travel mode is determined as one of a predetermined plurality of travel modes.

6. The method of claim 5, wherein the travel mode is determined in dependence on inertial measurement data recorded by the mobile device and one or more predetermined sets of inertial measurement data, wherein each predetermined set of inertial measurement data is associated with one of the predetermined plurality of travel modes.

7. The method of claim 6, wherein the travel mode is determined by utilizing the inertial measurement data and the predetermined sets as input to a neural network or other learning algorithm.

8. The method of claim 7, wherein the neural network or other learning algorithm is utilized to develop a decision tree, and the travel mode is determined in dependence thereon.

9. The method of claim 1, wherein the generalized identifier comprises a region identifier.

10. The method of claim 9, wherein the region identifier is at least a part of a postcode.

11. The method of claim 9, wherein the region identifier is associated with at least one tile of digital map data.

12. A computer-implemented method of tracking a mobile device, the method comprising:
receiving, at the mobile device, digital media associated with data indicative of a geographic area and a temporal duration;
creating, at the mobile device, a geofence corresponding to the geographic area in dependence on the mobile device accessing the digital media, wherein an expiry of the geofence is determined in dependence on the temporal duration;
communicating, from the mobile device to a computer server, data indicative of the mobile device entering the geofence after the expiry of the geofence.

13. The method of claim 12, wherein the mobile device accessing the digital media comprises displaying the digital media on a display of the mobile device.

14. The method of claim 12, wherein the mobile device accessing the digital media comprises a user of the mobile device interacting with the digital media through a user interface of the mobile device.

15. The method of claim 12, further comprising determining, at the mobile device, whether the mobile device has triggered the geofence.

16. The method of claim 15, wherein the mobile device is determined to have triggered the geofence if the location of the mobile device is within the geographic area during a time period between creating the geofence and the expiry of the geofence.

17. The method of claim 15, wherein the data communicated to the computer server comprises an indication of whether or not the mobile device triggered the geofence.

18. A mobile device, comprising:
one or more processors for executing computer-readable instructions;
a memory arranged to store computer readable instructions which, when executed by the one or more processors, perform a method according to claim 12.

19-20. (canceled)

21. A computer-readable data storage medium storing computer-readable instructions which, when executed by one or more processors, perform a method of:
receiving, at a mobile device, digital media associated with data indicative of a geographic area and a temporal duration;
creating, at the mobile device, a geofence corresponding to the geographic area in dependence on the mobile device accessing the digital media, wherein an expiry of the geofence is determined in dependence on the temporal duration;
communicating, from the mobile device to a computer server, data indicative of the mobile device entering the geofence after the expiry of the geofence.
